(19) United States
(12) Patent Application Publication
(10) Pub. No.: US 2025/0007222 A1
(43) Pub. Date: Jan. 2, 2025

(54) Power Outlet Device with Retractable Charging Cord

(71) Applicant: Michael Vlcek, Littleton, CO (US)

(72) Inventor: Michael Vlcek, Littleton, CO (US)

(21) Appl. No.: 18/731,585

(22) Filed: Jun. 3, 2024

Related U.S. Application Data
(60) Provisional application No. 63/523,669, filed on Jun. 28, 2023.

(51) Int. Cl. H01R 13/72; H01R 13/60; H01R 35/02; H02J 7/00

(52) U.S. Cl. CPC H01R 13/72; H01R 13/60; H01R 35/025; H02J 7/0045; H02J 2207/30

(57) ABSTRACT

A power outlet device with retractable charging cord is provided. The device is comprised of a body that includes plug openings, terminals, and a retractable charging cord housed within a reel mechanism. The reel inside the body contains a spring-assist mechanism and a ratchet-and-pawl system to manage the extension and retraction of the charging cord, which can be any standard type such as USB or lightning. In addition, the device functions as a traditional wall outlet via the plug openings.

### CROSS-REFERENCE TO RELATED APPLICATION

The present application claims priority to, and the benefit of, U.S. Provisional Application No. 63/523,669, which was filed on Jun. 28, 2023, and is incorporated herein by reference in its entirety.

### FIELD OF THE INVENTION

The present invention relates generally to the field of power outlets. More specifically, the present invention relates to a power outlet with a charging cord that can be retracted into the outlet when not in use. Accordingly, the present disclosure makes specific reference thereto. Nonetheless, it is to be appreciated that aspects of the present invention are also equally applicable to other like applications, devices, and methods of manufacture.

### BACKGROUND

Charging cords are commonly inserted into wall outlets to supply electrical power to personal electronics or various other devices. Once plugged in, charging cords often remain connected to the outlet even when they are not actively charging any devices. This persistent connection can lead to several issues. Primarily, it results in unnecessary clutter within living or working spaces, as these unused cords can dangle awkwardly or lie haphazardly around the area. Moreover, it poses a potential safety hazard as people may trip over them, and it may also contribute to energy wastage if the cords draw power even when not in use. Additionally, this clutter can detract from the aesthetic appeal of the space, making it look disorganized and untidy.

Therefore, there exists a long-felt need in the art for an improved wall outlet. There also exists a long-felt need in the art for a power outlet device with retractable charging cord that prevents a charging cord from cluttering an interior space. More specifically, there exists a long-felt need in the art for a power outlet device with retractable charging cord that allows a user to retract a charging cord into a power outlet when not in use.

The subject matter disclosed and claimed herein, in one embodiment thereof, comprises a power outlet device with retractable charging cord. The device is comprised of a body that includes plug openings, terminals, and a retractable charging cord housed within a reel mechanism. The reel inside the body contains a spring-assist mechanism and a ratchet-and-pawl system to manage the extension and retraction of the charging cord, which can be any standard type such as USB or lightning. In addition, the device functions as a traditional wall outlet via the plug openings.

In this manner, the power outlet device with retractable charging cord of the present invention accomplishes all the foregoing objectives and provides an improved wall outlet. During use, the device prevents a charging cord from cluttering an interior space. More specifically, the device allows a user to retract a charging cord into a power outlet when not in use.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a power outlet device with retractable charging cord comprised of a body comprised of at least one plug opening, at least one terminal, and at least one retractable charging cord.

The front surface of the body is comprised of at least one plug socket. The body is also comprised of at least one terminal. To secure the device to a junction box or other similar structure, the device may be comprised of at least one mounting tab that can receive a fastener.

The body is also comprised of at least one reel positioned within the body. The reel is preferably a spring-assist reel that receives at least one charging cord. The charging cord receives power in the same manner as the openings from the terminals. The reel is such that the cord can be pulled out from, and automatically locked in an extended position, from at least one opening of the front surface. The cord can also be partially retracted into the body when not in use.

The present invention is also comprised of a method of using the device. First, a device is provided comprised of a body comprised of at least one plug socket, at least one terminal, and at least one reel comprised of at least one charging cord. Then, the device can be wired to an existing electrical power system by connecting at least one wire of the system to at least one terminal of the device. Next, the device can be secured within a junction box by placing at least one fastener through a mounting tab of the device and into a receiving area of the junction box. A user can then pull a charging cord out from an opening in the body, wherein the charging cord automatically locks at a desired length when pulled. A user can then use the cord to charge a device. When finished charging, a user can retract the cord partially into the opening. A user can also plug a power cord into at least one plug socket of the device.

Accordingly, the power outlet device with retractable charging cord of the present invention is particularly advantageous as it provides an improved wall outlet. During use, the device prevents a charging cord from cluttering an interior space. More specifically, the device allows a user to retract a charging cord into a power outlet when not in use. In this manner, the power outlet device with retractable charging cord overcomes the limitations of existing power outlets known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a power outlet device with retractable charging cord of the present invention with a retracted charging cord in accordance with the disclosed architecture;

FIG. 2 illustrates an enhanced perspective view of one potential embodiment of a power outlet device with retractable charging cord of the present invention with an extended charging cord in accordance with the disclosed architecture; and

FIG. 3 illustrates a flowchart of a method of using one potential embodiment of a power outlet device with retractable charging cord of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved wall outlet. There also exists a long-felt need in the art for a power outlet device with retractable charging cord that prevents a charging cord from cluttering an interior space. More specifically, there exists a long-felt need in the art for a power outlet device with retractable charging cord that allows a user to retract a charging cord into a power outlet when not in use.

The present invention, in one exemplary embodiment, is comprised of a power outlet device with retractable charging cord. The device has a body comprised of at least one plug opening, at least one terminal, and at least one retractable charging cord. The front surface of the body is comprised of at least one plug socket. The body is also comprised of at least one terminal. To secure the device to a junction box or other similar structure, the device may be comprised of at least one mounting tab that can receive a fastener.

The body is also comprised of at least one reel positioned within the body, wherein the reel is preferably a spring-assist reel that receives at least one charging cord. The charging cord receives power in the same manner as the openings from the terminals. The reel is such that the cord can be pulled out from, and automatically locked in an extended position, from at least one opening of the front surface. The cord can also be partially retracted into the body when not in use.

The present invention is also comprised of a method of using the device. First, a device is provided comprised of a body comprised of at least one plug socket, at least one terminal, and at least one reel comprised of at least one charging cord. Then, the device can be wired to an existing electrical power system by connecting at least one wire of the system to at least one terminal of the device. Next, the device can be secured within a junction box by placing at least one fastener through a mounting tab of the device and into a receiving area of the junction box. A user can then pull a charging cord out from an opening in the body, wherein the charging cord automatically locks at a desired length when pulled. A user can then use the cord to charge a device. When finished charging, a user can retract the cord partially into the opening. A user can also plug a power cord into at least one plug socket of the device.

Accordingly, the power outlet device with retractable charging cord of the present invention is particularly advantageous as it provides an improved wall outlet. During use, the device prevents a charging cord from cluttering an interior space. More specifically, the device allows a user to retract a charging cord into a power outlet when not in use. In this manner, the power outlet device with retractable charging cord overcomes the limitations of existing power outlets known in the art.

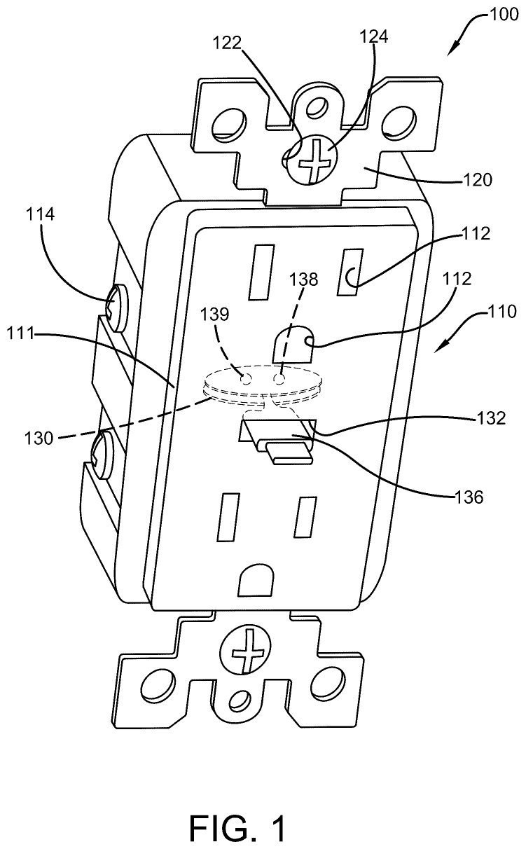

Referring initially to the drawings, FIG. 1 illustrates a perspective view of one potential embodiment of a power outlet device with retractable charging cord 100 of the present invention with a retracted charging cord 136 in accordance with the disclosed architecture. The device 100 is comprised of a body 110 comprised of at least one plug opening 112, at least one terminal 114, and at least one retractable charging cord 136.

The body 110 of the device 100 is preferably rectangular but may be any shape used with power outlets. The body 110 is preferably made from a non-conductive material. The front surface 111 of the body 110 is comprised of at least one plug socket 112. The socket 112 receives a male member of a power cord, such as, but not limited to, a 110 v to 250 v power cord. The device 100 preferably has sockets 112 that are neutral, hot, and grounded in any combination.

The body 110 is also comprised of at least one terminal 114. The terminal 114 is preferably a threaded terminal of any style and configuration that can be used to secure a wire to the device 100 to place the device 100 in powered electrical communication with an existing electrical power source. The device 100 preferably has hot, neutral, and ground terminals 114.

To secure the device 100 to a junction box or other similar structure, the device 100 may be comprised of at least one mounting tab 120. The tab 120 is preferably flexible and is comprised of at least one opening 122 that allows at least one fastener 124 to be placed through the tab 120 to secure the device 100 within a junction box. The fastener 124 is preferably, but not limited to, a threaded bolt. In one embodiment, the opening 122 is comprised of a threaded opening.

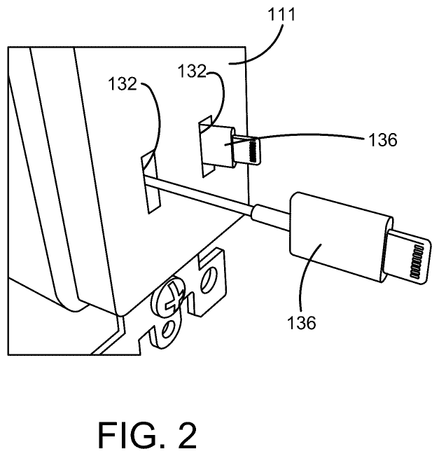

The body 110 is also comprised of at least one reel 130. The reel 130 is positioned within the body 110. The reel 130 is preferably a spring-assist reel 130. The reel 130 receives at least one charging cord 136 that receives power in the same manner as the openings 112 from the terminals 114. The reel 130 is such that the cord 136 can be pulled out from, and automatically locked in an extended position, from at least one opening 132 of the front surface 111, as seen in FIG. 2. The cord 136 can also be partially retracted into the body 110 when not in use. More specifically, the reel 130 is comprised of at least one spring mechanism 138. The mechanism 138 is preferably a flat spiral spring. As the cord 136 is pulled out, the spring 138 winds tighter, storing more energy. The energy stored in the tensioned spring is what pulls the cord back into the body 110 when released. Further, the reel 130 is comprised of at least one ratchet-and-pawl mechanism 139 that engages when the cord 136 is extended to temporarily stop the spring 138 from unwinding and retracting the cord 136 when the cord 136 is in use. To retract the cord 136, a user can tug the cord 136 to disengage the mechanism 139, allowing the spring 138 to unwind and pull the cord 136 back into the reel 130 and body 110. The charging cord 136 may be any charging cord style such as, but not limited to, a USB cord, a lightning cord, etc.

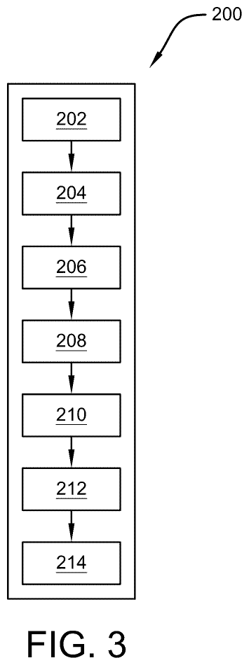

The present invention is also comprised of a method of using 200 the device 100, as seen in FIG. 3. First, a device 100 is provided comprised of a body 110 comprised of at least one plug socket 112, at least one terminal 114, and at least one reel 130 comprised of at least one charging cord 136 [Step 202]. Then, the device 100 can be wired to an existing electrical power system by connecting at least one wire of the system to at least one terminal 114 of the device 100 [Step 204]. Next, the device 100 can be secured within a junction box by placing at least one fastener 124 through a mounting tab 120 of the device 100 and into a receiving area of the junction box [Step 206]. A user can then pull a charging cord 136 out from an opening 132 in the body 110, wherein the charging cord 136 automatically locks at a desired length when pulled [Step 208]. A user can then use the cord 136 to charge a device [Step 210]. When finished charging, a user can retract the cord 136 partially into the opening 132 [Step 212]. A user can also plug a power cord into at least one plug socket 112 of the device 100 [Step 214].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “power outlet device with retractable charging cord” and “device” are interchangeable and refer to the power outlet device with retractable charging cord 100 of the present invention.

Notwithstanding the foregoing, the power outlet device with retractable charging cord 100 of the present invention and its various components can be of any suitable size and configuration as is known in the art without affecting the overall concept of the invention, provided that they accomplish the above-stated objectives. One of ordinary skill in the art will appreciate that the size, configuration, and material of the power outlet device with retractable charging cord 100 as shown in the FIGS. are for illustrative purposes only, and that many other sizes and shapes of the power outlet device with retractable charging cord 100 are well within the scope of the present disclosure. Although the dimensions of the power outlet device with retractable charging cord 100 are important design parameters for user convenience, the power outlet device with retractable charging cord 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A power outlet device with retractable charging cord comprising:
a body comprised of an opening;
a plug socket;
a terminal;
a reel positioned inside the body; and
a charging cord.

2. The power outlet device with retractable charging cord of claim 1, wherein the charging cord is comprised of a USB cord or a lighting cord.

3. The power outlet device with retractable charging cord of claim 1, wherein the reel is comprised of a spring.

4. The power outlet device with retractable charging cord of claim 1, wherein the reel is comprised of a ratchet and pawl mechanism.

5. The power outlet device with retractable charging cord of claim 1, wherein the terminal is comprised of a threaded terminal.

6. The power outlet device with retractable charging cord of claim 1, wherein the body is comprised of a non-conductive material.

7. A power outlet device with retractable charging cord comprising:
a body comprised of a first opening;
a mounting tab;
a plug socket;
a terminal;
a reel positioned inside the body; and
a charging cord.

8. The power outlet device with retractable charging cord of claim 7, wherein the mounting tab is comprised of a second opening.

9. The power outlet device with retractable charging cord of claim 7, wherein the charging cord is comprised of a USB cord or a lighting cord.

10. The power outlet device with retractable charging cord of claim 7, wherein the reel is comprised of a spring.

11. The power outlet device with retractable charging cord of claim 7, wherein the reel is comprised of a ratchet and pawl mechanism.

12. The power outlet device with retractable charging cord of claim 7, wherein the terminal is comprised of a threaded terminal.

13. The power outlet device with retractable charging cord of claim 7, wherein the body is comprised of a non-conductive material.

14. The power outlet device with retractable charging cord of claim 8, wherein the second opening is comprised of a threaded opening.

15. A method of using a power outlet device with retractable charging cord, the method comprising the following steps:
providing a power outlet device with retractable charging cord comprised of a body comprised of a plug socket, a terminal, and a reel comprised of a charging cord;
wiring the power outlet device with retractable charging cord to an existing electrical power system by connecting a wire of the existing electrical power system to the terminal;
securing the power outlet device with retractable charging cord within a junction box via placing a fastener through a mounting tab of the power outlet device with retractable charging cord and into a receiving area of the junction box;
pulling the charging cord out from an opening in the body;
using the charging cord to charge a device; and
retracting the charging cord partially into the body.

16. The method of using a power outlet device with retractable charging cord of claim 15, wherein the charging cord is comprised of a USB cord or a lightning cord.

17. The method of using a power outlet device with retractable charging cord of claim 15, wherein the reel is comprised of a spring.

18. The method of using a power outlet device with retractable charging cord of claim 15, wherein the reel is comprised of a ratchet and pawl mechanism.

19. The method of using a power outlet device with retractable charging cord of claim 15, wherein the mounting tab is comprised of an opening.

20. The method of using a power outlet device with retractable charging cord of claim 15, wherein the body is comprised of a non-conductive material.
